(19) United States
(12) Patent Application Publication
(10) Pub. No.: US 2018/0253761 A1
(43) Pub. Date: Sep. 6, 2018

(54) Cross-Enterprise Matching of Assets to Members

(71) Applicant: Conduit Ltd., Ness Ziona (IL)

(72) Inventors: Ronen Shilo, Ness Ziona (IL); Dror Erez, Ness Ziona (IL); Liran Mayost, Ness Ziona (IL); Danny Albocher, Ness Ziona (IL); Yair Holtzer, Ness Ziona (IL)

(73) Assignee: Conduit Ltd., Ness Ziona (IL)

(21) Appl. No.: 15/448,926

(22) Filed: Mar. 3, 2017

(51) Int. Cl. G06Q 30/02; G06F 17/30

(52) U.S. Cl. CPC G06Q 30/0263; G06F 17/30867; G06Q 30/0233; G06Q 30/0256

(57) ABSTRACT

Method, system and product for cross-enterprise matching of assets to members. One method comprises generating a plurality of asset templates redeemable in a set of vendors participating in a campaign; and applying a matching logic to uniquely and persistently match each asset template with a member, wherein the matching logic is based on a universal member property, wherein the universal member property is a property of a member that is applicable by each participating vendor and is vendor-defined and the value of which is automatically computed based on a vendor definition. Another method comprises determining a modified campaign definition using a campaign modification obtained from a vendor and based on a campaign definition; generating asset templates based on the modified campaign definition; applying a matching logic to obtain a list of matched members each of which is persistently matched with an asset template.

### TECHNICAL FIELD

The present disclosure relates to database management systems in general, and to methods and systems for matching assets in a cross-enterprise database management system using a uniform cross-enterprise language, in particular.

### BACKGROUND

Many enterprises retain member data in electronic databases. Such databases retain information obtained directly or indirectly from the members, such as via explicit forms, analyzing observed behavior, or the like.

In the information age, such data may be of great value and hence the enterprises may avoid disclosing the data to third parties. In addition, privacy policies may be put in place preventing the enterprise from disclosing information to third parties. Even in cases where the data is useful for targeting advertisements to specific members, based on specific characteristics of the members, targeting may be performed by the enterprise without exposing the confidential information to the advertiser.

An advertiser may decide to perform sales promotion by issuing discounts or providing promotional giveaways or even goods. Each advertiser's decision to who the promotion is applied is different and relies on the different database schemes. The matching query used by each advertiser is, thus, different.

In the online environment, an advertiser may decide to dynamically serve an advertisement or other promotional message to a user surfing the web. The matching of the user to the advertiser's predetermined designation is done dynamically and on-demand when the user arrives. Hence, the advertisement is distributed on a first come—first served basis, depleting the advertiser's advertisement credit without necessarily reaching the best audience. In such a case, the same advertisement is also served to different users, and does not uniquely identify a user.

Furthermore, in the online environment, ad serving is performed based on the advertiser's information. The database of the publisher (e.g., the website) is not used for matching ads. Instead, the advertiser, through the use of client-side code tracks the activity of the user in this website and in others. Hence, information known to the website but not discovered by the advertiser's tracking system, is not used for matching ads.

Under retargeting activity, the user's online activity is monitored. Based on her past activity, ad matching is performed. However, retargeting still requires that the user be online when the new advertisement is served to her device.

### BRIEF SUMMARY

One exemplary embodiment of the disclosed subject matter is a computer program product comprising a non-transitory computer readable storage medium retaining program instructions, which program instructions when read by a processor, cause the processor to perform a method, wherein the process is operating in a computerized environment, wherein the computerized environment comprises a plurality of data sets each of which retaining information relating to members in a customer base of a vendor, wherein the data sets potentially comprise confidential information regarding members that is not accessible to any entity external to the vendor, wherein the computerized environment comprises a plurality of catalogs each of which retaining a plurality of products or services offered by a vendor, wherein said method comprising: generating a plurality of asset templates, wherein each asset template defines a benefit to a member and being redeemable through each one of a set of vendors participating in a campaign; applying a matching logic to uniquely match each asset template with a single member, wherein the matching logic comprises at least one criterion used to determine whether a member is a match to an asset, wherein the at least one criterion comprise a universal member property, wherein the universal member property is a property of a member that is applicable by each participating vendor and is vendor-defined, wherein a value of the universal member property for a member with respect to a vendor is automatically computed based on a vendor definition and based on information of the member retained in a data set of the vendor, whereby providing a uniform cross-enterprise language useful for querying member information in data sets of different participating vendors, wherein said applying the matching logic comprises: determining a query, wherein the query comprises a filtering condition that is based on the universal member property; applying the query on the data sets; retrieving a list of matched members based on the query; and for each member in the list of matched members, persistently matching an asset template.

Optionally, the list of matched members is obtained by filtering a result set returned from the data sets according to a filtering criterion.

Optionally, the filtering criterion comprises a size limit parameter, wherein the size limit parameter is derived from a total number of asset templates allotted for the campaign.

Optionally, each result in the result set is associated with a match ranking, wherein the filtering criterion is selected from the group consisting of: top ranking results according to associated match ranking; results with associated match ranking exceeding a predetermined threshold.

Optionally, the filtering criterion is based on a last update time of the members, wherein the last update time is a latest time out of the following: a last transaction time; and a last connection time wherein the last transaction time is a time of a last purchase made by the member, wherein the last connection time is a time of a last interaction of the member with an application program of the participating vendor.

Optionally, the value of the universal member property is re-computed based on raw data in the data set of the vendor.

Optionally, the universal member property is selected from the group consisting of: expenditure level; products or services preference; payment habit; demographic property; engagement characterization and any combination thereof

Optionally, the universal member property is a Very Important Person (VIP) property indicating the member is considered a VIP customer for the vendor.

Optionally, the universal member property is computed based on raw data comprising information selected from the group consisting of: consumption data, a demographic property, engagement information, information relating to loyalty and redemption of loyalty-related benefits, environmental properties, and a combination thereof

Optionally, each data set comprises a labeling for members denoting a respective universal member property, wherein the labeling is determined based on information of each member retained in the data set.

Optionally, different vendors apply different criteria for labeling a member with a given universal member property.

Optionally, the members are users capable of interacting with a digital representation of a participating vendor, whereby a member may be in an online or offline state with respect to the digital representation of the participating vendor, wherein the matching of an asset template to a member is performed while some of the members are in an online state and some of the members are in an offline state.

Optionally, a first portion of members are notified of the matched asset template by a digital representation of a participating vendor, wherein a second portion of members are notified of the matched asset template at a point of sale of the participating vendor without interacting with the digital representation of the participating vendor.

Optionally, the asset template is defined using a universal catalog property denoting corresponding products or services in different catalogs, whereby providing a uniform cross-enterprise language useful for defining the asset template in a uniform manner for each participating vendor.

Optionally, the corresponding products or services are selected from the group consisting of: branded and generic versions of a same product or service; different species within a genus of products or services; and any combination thereof

Optionally, the universal catalog property denotes a class of products or services in a same catalog, whereby a redemption condition defined using the universal catalog property is met based on an activity relating to any product or service of the class.

Optionally, the asset template defines a redemption condition that is contingent on an action by the member, wherein the redemption condition relates to a sequence of events over time, each of which pertaining to a separate action to be performed by the member.

Optionally, the sequence of events comprises a sequence of purchases made by the member.

Optionally, the plurality of asset templates are cross-enterprise assets identically defined for and redeemable by the participating vendors.

Optionally, in response to said matching, determining a vendor in which the asset template is redeemable; and generating a concrete asset based on the asset template, wherein the concrete asset is redeemable only by the vendor.

Optionally, the campaign is launched responsive to a negotiation process between a brand owner providing funding of the benefit and each of a plurality of vendors, wherein the negotiation process comprises an offer sent from the brand owner to the vendor, an acceptance, decline or modification sent by the vendor to the brand owner in response to the offer, and acceptance, decline or re-modification sent by the brand owner to the vendor in response to the modification.

Optionally, the campaign is launched responsive to a negotiation process between a the set of vendors, wherein the negotiation process comprises an offer sent from a first vendor to one or more other vendors, an acceptance, decline or modification sent by each of the one or more other vendors to the first vendor in response to the offer, and acceptance, decline or re-modification sent by the first vendor in response to the modification.

Optionally, consumer behavior data relating to members' response to the campaign are gathered and retained in the respective data sets of vendors in response to the benefit being redeemed, wherein the method further comprising determining a continuation campaign wherein the matching logic is configured to apply a matching criterion that is defined, at least partially, as a function of the consumer behavior data, whereby members that previously redeemed the benefit of the campaign are re-targeted for the continuation campaign without confidential information thereof being disclosed.

Optionally, the query is configured to be responsive to computed and non-computed data in the data sets, wherein said applying the matching logic further comprises: applying a second query on an aggregated data set comprising the data sets, whereby matching of a member in a data set of a first vendor is potentially based on information retained in a data set of a second vendor.

Optionally, the aggregated data set comprises a data set of an additional vendor, wherein the additional vendor does not participate in the campaign, whereby matching is performed while taking into account information external to the set of vendors.

Another exemplary embodiment of the disclosed subject matter is a system comprising a processor and a memory, wherein the memory retaining the computer program product according to the above. Additionally or alternatively, the processor may be configured to perform the method defined in the computer program product according to the above.

Yet another exemplary embodiment of the disclosed subject matter is a method implemented in a computerized environment, wherein the computerized environment comprises a plurality of data sets each of which retaining information relating to members in a customer base of a vendor, wherein the data sets potentially comprise confidential information regarding members that is not accessible to any entity external to the vendor, wherein said method comprising: obtaining a campaign definition, wherein the campaign definition comprises an asset template definition, wherein the asset template definition defines a quantity of assets template to be generated in a campaign, wherein the asset template definition defines a benefit to a member that is redeemable through each one of a set of vendors participating in a campaign, wherein the set of vendors comprises a first vendor and a second vendor, wherein the campaign definition comprises a generic matching logic to uniquely match an asset template with a single member, wherein the generic matching logic is applicable to each vendor of the set of vendors participating in the campaign; obtaining a campaign modification from the first vendor, wherein the campaign modification is a vendor-defined addition to the campaign definition; determining a modified campaign definition based on the campaign definition and based on the campaign modification, wherein the modified campaign defines different rules for the first vendor than for the second vendor based on the campaign modification; generating set of asset templates based on the modified campaign definition, wherein each asset template defines a benefit to a member and being redeemable through each one of the set of vendors; applying a matching logic based on the modified campaign definition to obtain a list of matched members; and for each member in the list of matched members, persistently matching an asset template from the set of asset templates.

Optionally, the campaign modification comprises a modified definition of an asset template, whereby an asset template that is matched to a member of the first vendor is different than an asset template that is matched to a member of the second vendor.

Optionally, the campaign modification defines a redemption condition for asset templates that is contingent on an action by the member, whereby the asset template matched to the member of the first vendor has a different redemption condition than the asset template matched to the member of the second vendor.

Optionally, the campaign modification defines an added benefit to the asset template, whereby the asset template matched to the member of the first vendor bestows the benefit and the added benefit, while the asset template matched to the member of the second vendor bestows the benefit without the added benefit.

Optionally, the campaign modification comprises an added matching logic defining one or more added constraints on matching an asset template with a member of the first vendor, whereby a concrete matching logic is determined based on the generic matching logic and based on the added matching logic, wherein said applying comprises applying the concrete matching logic with respect to the first vendor and applying the generic matching logic with respect to the second vendor, whereby different matching logics are applied to different vendors.

Optionally, a second concrete matching logic is determined based on the generic matching logic and based on a second campaign modification obtained from the second vendor, wherein said applying comprises applying the second concrete matching logic with respect to the second vendor.

Yet another exemplary embodiment of the disclosed subject matter is a computerized apparatus having a processor and a memory, wherein the computerized apparatus operating in a computerized environment, wherein the computerized environment comprises a plurality of data sets each of which retaining information relating to members in a customer base of a vendor, wherein the data sets potentially comprise confidential information regarding members that is not accessible to any entity external to the vendor, wherein said processor being adapted to perform the steps of: obtaining a campaign definition, wherein the campaign definition comprises an asset template definition, wherein the asset template definition defines a quantity of assets template to be generated in a campaign, wherein the asset template definition defines a benefit to a member that is redeemable through each one of a set of vendors participating in a campaign, wherein the set of vendors comprises a first vendor and a second vendor, wherein the campaign definition comprises a generic matching logic to uniquely match an asset template with a single member, wherein the generic matching logic is applicable to each vendor of the set of vendors participating in the campaign; obtaining a campaign modification from the first vendor, wherein the campaign modification is a vendor-defined addition to the campaign definition; determining a modified campaign definition based on the campaign definition and based on the campaign modification, wherein the modified campaign defines different rules for the first vendor than for the second vendor based on the campaign modification; generating set of asset templates based on the modified campaign definition, wherein each asset template defines a benefit to a member and being redeemable through each one of the set of vendors; applying a matching logic based on the modified campaign definition to obtain a list of matched members; and for each member in the list of matched members, persistently matching an asset template from the set of asset templates.

Optionally, the campaign modification comprises a modified definition of an asset template, whereby an asset template that is matched to a member of the first vendor is different than an asset template that is matched to a member of the second vendor.

Optionally, the campaign modification comprises an added matching logic defining one or more added constraints on matching an asset template with a member of the first vendor, whereby a concrete matching logic is determined based on the generic matching logic and based on the added matching logic, wherein said applying comprises applying the concrete matching logic with respect to the first vendor and applying the generic matching logic with respect to the second vendor, whereby different matching logics are applied to different vendors.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 shows a computerized environment, in accordance with some exemplary embodiments of the subject matter;

FIG. 2 shows a schematic diagram of data sets, in accordance with some exemplary embodiments of the disclosed subject matter;

FIG. 3 shows a flowchart diagram of a method, in accordance with some exemplary embodiments of the subject matter;

FIGS. 4A-4C show flowchart diagrams of methods, in accordance with some exemplary embodiments of the subject matter;

FIG. 5 shows an apparatus in accordance with some exemplary embodiments of the disclosed subject matter;

FIG. 6 shows a flowchart diagram of a method, in accordance with some exemplary embodiments of the subject matter; and

FIG. 7 shows a flowchart diagram of a method, in accordance with some exemplary embodiments of the subject matter.

### DETAILED DESCRIPTION

One technical problem dealt with by the disclosed subject matter is to provide for a cross-enterprise matching capabilities based on properties that are expressed differently in different vendors' data sets. In some cases, the same property may be expressed differently in different vendors' data sets, such as in view of different database schemes (e.g., having different fields). Additionally or alternatively, the same property may be expressed differently in view of the different activities, subject matter, or crowd of each vendor. Consider for example, a desire to target “big spender” patrons of a business. A big spender at MCDONALD'S™ would spend much less than a big spender at TIFFANY'S™. Also, the MCDONALD'S™ big spender may be defined based on a total sum of expenses at the store, while that of TIFFANY'S™ may be defined based on the average price of an item purchased (e.g., differentiating the big-spender patron who purchased one item for 10,000 USD, from the frequent buyer who purchased 20 items at 500 USD each).

Another technical problem dealt with by the disclosed subject matter is to provide for an efficient system for distributing redeemable assets to members. The redeemable assets may be cross-enterprise assets redeemable by different vendors. The assets may be distributed by a brand-owner who himself may or may not be a vendor.

Yet another technical problem dealt with by the disclosed subject matter is to preserve privacy of customers of one vendor, while allowing a third-party to approach them with relevant benefits. One aspect of such technical problem is allowing the third-party to use data retained by the vendor in order to target the audience of the campaign. Another aspect of such technical problem is allowing the third-party to provide follow-on campaigns to the audience of a previous campaign or portion thereof, without disclosing their identity.

Yet another technical problem dealt with by the disclosed subject matter is to enable a generation and application of an advertisement campaign desired by a brand owner, while allowing each vendor to gain control on the definitions of such campaign when applied on its customers, thereby allowing a win-win-win situation where the brand owner receives the benefit it desires, while allowing each vendor to ride on the campaign for its purposes. It is desired, however, that the campaign will still be handled a single campaign albeit the different implementations thereof for different vendors.

One technical solution is to generate asset templates and apply matching logic thereon. Each asset template may define a benefit to a member and being redeemable through each one of a set of vendors participating in a campaign. The asset template may define a redemption condition that is contingent on an action by the member. The member may be any member of a customer base of a vendor. In some exemplary embodiments, the asset template may itself be a cross-enterprise asset that can be redeemed by any vendor. Additionally or alternatively, a concrete asset may be generated based on the asset template in response to matching between the asset template and a member and based on the identity of the vendor in which customers base the member is comprised. Different concrete assets may be generated for different vendors, each having a potential different definitions and conditions. However, in some exemplary embodiments, the conditions set at the asset template may be generally preserved by the different concrete assets.

In some exemplary embodiments, the matching logic may be applied to uniquely match each asset template with a single member. Hence, a single asset is uniquely matched to a member. The matching relationship may be consistent over time, so that the asset template is considered matched to the member thereafter. In some exemplary embodiments, a member may dispose of an asset template. In such a case, the asset template may be matched with another alternative member.

In some exemplary embodiments, the matching logic may utilize a uniform cross-enterprise language in order to query member information in member data sets. The cross-enterprise language may comprise universal member properties and traditional member properties. The universal member property may be applicable by different vendors at potentially different manners. The universal member property may relate to a universal property, which is concretized differently at different database schemes or at different subject matter areas. Getting back to the example above, a universal member property of “big spender” may be treated differently by the vendor MCDONALD'S™ and by the vendor TIFFANY'S™. The universal member property may be interpreted differently due to semantical differences in different vendors. Hence, a “young” customer may be defined as 6-12 age old by BURER KING™, and as 35 or younger by MERCEDES BENZ™. Additional traditional member properties that are defined uniformly by the different vendors may also be provided. For example: a traditional member property relating to an age of the member (e.g., age between 18 and 35).

In some exemplary embodiments, the universal member property may be a property whose value is computed based on other data in the same data set. For example, the universal member property of “big spender” may be the top 10% of the customers, based on the history in the last 6 months. Such information may be ascertainable for each member from the relevant data set, and computed accordingly. Additionally or alternatively, each vendor may supply a different computation formula or different definition for the universal member property, providing a different implementation for the same property in different vendors. A “VIP” property may indicate Very Important Person (VIP) customers of the vendor. Each vendor may define who are his most esteemed customers and provide a different definition thereof. Still, a general query may be issued relating to VIP customers in several vendors, thanks to the use of the universal member property.

In some exemplary embodiments, the universal member property may be defined for a vendor, also referred to as vendor-defined. The vendor-defined universal member property may be provided by the vendor or by another entity. In some exemplary embodiments, an owner of a framework in accordance with the disclosed subject matter may provide for default definitions for universal member properties, which each vendor may override or leave as is.

In some exemplary embodiments, based on the matching logic, a query that comprises a filtering condition is generated. The query may be based, at least in part, on the universal member property, and is thus cross-enterprise. The query may be applied on the data sets of all participating vendors. In some exemplary embodiments, the query may select members of a vendor data set based on raw data appearing in the data set (e.g., explicit data received from the customer, during interaction with the customer in the past, or the like) of the vendor, based on computed data that is computed based on the raw data in the vendor's data set, or the like. In some exemplary embodiments, matching may be dependent on information about the same customer in different vendors' data sets. For example, an “age” data may not be available at the vendor's data set but may be available for customers of a second or third vendor. If a customer appears in the vendor's data set as well as in one of the second or third data sets, her age may be ascertainable and used to decide whether the customer will be matched as a customer of the vendor or not. As another example, only customers who are identified as “VIP”s in each data set they appear may be selected, thereby excluding the MCDONALD'S™ “VIP” who is not also a “VIP” for TIFFANY'S™. It will be noted that the members of different vendors' data sets may be identified using any unique identifier, such as an ID number, a FACEBOOK™ profile information, an email address, a device identifier (e.g., SSAID, MAC (Media Access Control) address, IMEI (International Mobile Station Equipment Identity), ANDROID™ Advertiser ID, or the like) of the device used by the customer (e.g., when using an app), or the like. Using such unique identifier, aggregated raw and computed data of the customer may be obtained from the different data sets and used for making matching decisions.

In some exemplary embodiments, a list of matched members may be obtained. Each such member may be persistently matched to the asset template (or concrete asset generated based thereon). In some exemplary embodiments, the list of matched members may be obtained by filtering a results set returned from the data sets according to a filtering criterion. The filtering criterion may be, for example, based on a size limit. In one example, the size limit may be derived from the total number of available asset templated which were allotted to be matched. In some exemplary embodiments, the results may be ranked and the filtering criterion obtains the top ranking results or results with ranking above a threshold.

In some exemplary embodiments, the filtering criterion may be based on a last update time of the member. The last update time may be a last transaction time of the member, a last connection time of the member, or the like. In some exemplary embodiments, the vendor may be an offline vendor with a loyalty plan allowing the vendor to track last transaction time of each member. Additionally or alternatively, the vendor may provide for an online representation thereof, such as an app, a website, or the like. The member may connect to the online representation and a last connection time may be considered as the last time the member was active, even if no transaction was performed. A campaign may, thus, target members who have been recently active, based on different metrics or criteria. In some exemplary embodiments, update times may be stored and past connection usages may be queried, such as users who were active at least twice in a year, users who are active in intervals of three months or less, or the like.

In some exemplary embodiments, the universal member property may be defined by each vendor, potentially in a different manner. The definition may define a computation formula to compute the value of the universal member property. In some exemplary embodiments, the universal member property may be a computed property whose value is computed based on raw properties appearing the same data set and/or based on other computed properties in the same data set. The value of the universal member property may be re-computed in a continuous manner (e.g., whenever a raw data is added, changed, or removed, which can potentially effect the value). Additionally or alternatively, re-computation may be performed periodically. The re-computation may be performed in a batch process for the entire data set or for a substantial portion thereof, every day, every week, every month, or the like. In some exemplary embodiments, the value may be computed on-demand, so that if the value is requested, and the value may have changed (e.g., in view of a change of the raw properties it depends on, either directly or indirectly via another computed property), the value is re-computed.

In some exemplary embodiments, the universal member property may be a property relating to expenditure level, payment habits, products/services preferences, demographic property (e.g., age, family status), engagement characterization (e.g. engagement with notifications sent by the vendor (e.g., frequently reads email), engagement with the online representation of the vendor (e.g., logs-in during weekends), loyalty-related activities (e.g., tends to redeem benefits, redeems benefits without purchasing items in addition to any benefit-related items), or the like. In some exemplary embodiments, the universal member property may be an indication that the member is considered as associated with a group of customers, in accordance with the vendor's definitions. As an example, a VIP property may be used to indicate that the customer is considered as one of the vendor's VIP customers.

In some exemplary embodiments, the universal member property may be computed based on raw data that is related to different domains. In some cases, data from the consumption habits domain may be used, such as the items the member purchases, the composition of her shopping cart, coupling of items in her shopping cart (e.g., purchasing shirts of different sizes may be indicative of a the member being a representative of a family; similarly, purchasing a children meal may be indicative that the member is a family), or the like. Additionally or alternatively, data from the demographic characteristics domain may be used, such as age, geographic location, ethnicity, or the like. Additionally or alternatively, engagement information may be used, such as engagement measurements with respect to an online representation of the vendor (e.g., logging in, pressing buttons, types of interactions), engagement in an offline environment (e.g., interaction with a human representative), or the like. Additionally or alternatively, information related to loyalty and redemption of loyalty-related benefits may be used as a basis for computing the universal member property. The loyalty-related information may include information regarding whether, when and how a member redeemed previously provided benefits. For example, the information may include an elapsed time between the provisioning of the asset and the redemption of the benefit of the asset, the composition of the shopping cart when redemption was performed, tendency to redeem, timing of redemption (e.g., which day of the week, at which hours, or the like). Additionally or alternatively, data from environmental properties representing the environment in which the member is active, may be used. The environmental property may include, for example, weather information, a date and time, an external events such as an election, or the like.

In some exemplary embodiments, the universal member property may be a property that is temporary relevant for the member. As an example, an “in market for beer” universal member property may be computed based on current and previous activities of a member and may be indicative that the member is likely to purchase a beer. The member may be likely to currently purchase the beer or may be likely to purchase it in the near future.

In some exemplary embodiments, the universal member property may have a degree allowing different degrees of the property. For example, VIP member property may have a degree indicating which members are more important in between the VIP members.

In some exemplary embodiments, the universal member property may have a confidence level, indicating a confidence level of the existence of the property. For example, if the universal member property is “family” indicating the member is making her purchases for a family, there may be a confidence level indicating a confidence level in the prediction that the member is indeed a “family”.

In some exemplary embodiments, predetermined labels may be used to indicate different universal member properties. Setting a label may be indicative to setting the property as TRUE (e.g., the member is a VIP customer, the member is a “big spender”, or the like). Labeling may be performed based on the values in the data set, such as the values relating to the member herself and potentially values relating to other members. As an example, the formula to determining a “big spender” may be an absolute formula checking the average expenditure of the member, checking the total expenditure, or the like. In such a case, the computation is based solely on data relating to the member herself (e.g., her past purchases). As an alternative example, the formula may be a relative formula relating to the expenditure level being in a 10% percentile. In such a case, the computation is based on the data relating to the member herself as well as to the data relating to all other members (so as to identify what is the 10% percentile).

In some exemplary embodiments, some or all of the members of a vendor's customer data set may utilize an application program (“app”) using a mobile device, such as a mobile phone, a Personal Digital Assistant (PDA), a tablet computer, a laptop computer, or the like. The app may be, for example, a customer's loyalty program app of the vendor, a store app of the vendor, or the like. Each user may have assets associated thereto and viewable via the app. The asset template may be assigned to users irrespectively to whether or not the users are currently logged in to the app, actively using the app, or the like. In some exemplary embodiments, the asset template may be viewable via the app. In some exemplary embodiments, a push notification, a short message, or a similar notification may be transmitted to the user via the mobile device. In some exemplary embodiments, some of the users to which the asset templates are matched, may not have an installed app at all. Such members may be notified of their asset templates when interacting with the vendor, such as at a Point of Sale (PoS), where the information may be provided via a PoS device. In some exemplary embodiments, a waiter may be notified of the relevant asset template a customer has, in response to providing the customer's identification means (e.g., magnetic card, user name, ID number, phone number, or the like) to an electronic device. The waiter may then manually inform the customer of her available asset templates that may be available to be used in the present meal. In some cases, the waiter may inform the customer of any newly added asset template, regardless of whether it may be redeemed in the present meal. Additionally or alternatively, the PoS device may only provide notifications with respect to assets that the customer was not previously informed of, such as via the app. In some cases, the PoS device may only provide notifications with respect to customers who do not have an app, who did not log in to the app since the asset was added, or the like.

It will be noted that the disclosed subject matter is not limited to the use of an app, and any digital representation of a vendor may be utilized, such as but not limited to a website, a chatbot interface, or the like. A member may be in an online state (e.g., logged in to the website, using the app, or the like) or in an offline state with respect to the digital representation.

In some exemplary embodiments, the asset template may define a redemption condition which defines when the benefit can be redeemed. In some cases, the redemption condition may be contingent on an action by the member. For example, the benefit may be provided after purchasing a predetermined amount of items in the present meal or in previous meals, such as in case of a punch card (e.g., get one beer free, after buying 10 beers). As another example, benefit may be a specific sale, such as a 1+1 sale, and hence the benefit is contingent on the member buying the first item.

Similarly, get a beer when ordering a hamburger, is also contingent on the member purchasing the hamburger.

In some exemplary embodiments, the properties of the asset template, such as the redemption condition, the benefit or the like, may be defined in a uniform manner for different vendors, using uniform cross-enterprise language. In some exemplary embodiments, the redemption condition may comprise a universal catalog property denoting products or services provided by the vendor. Each vendor may define valuation of universal catalog property. Additionally or alternatively, the universal catalog property may be translated to different concrete items in different catalogs of different vendors. For example, consider the benefit of a CARLSBERG™ beer. Each vendor may define such item in a different manner, using a different name, a different serial number, or the like. The benefit of a CARLSBERG™ beer may be defined using a universal catalog property, which is translated to the correct instance of the same product in the catalogs of the different vendors. As another example, the redemption condition may be purchasing of a hamburger. The redemption condition may be defined using a universal catalog property indicating hamburger. Such property may be translated to different concrete items in catalogs of vendors, such as BIG MAC™ in one vendor, WHOPPER™ in another, 160 gr hamburger, in yet another. Some instantiations may be generic and branded versions of the same product or service. Additionally or alternatively, some instantiations may be different species within a genus of products or services. In some exemplary embodiments, the universal catalog property may denote a class of products or services in a same catalog.

In some exemplary embodiments, the asset template may define a redemption condition which requires a sequence of events over time. Each event may relate to a separate action by the member. As the asset template is uniquely and persistently matched with the member, the sequence of events may be tracked by the system over a long period of time. When the sequence of events is identified, the redemption condition may be considered as met, and the member may redeem the benefit defined by the asset template. In some exemplary embodiments, the sequence of events may be a sequence of separate purchases by the member over time. Additionally or alternatively, the sequence may be a sequence of log-in actions to an app, sharing items over a social network, reacting to items in a social network (e.g., “liking” items on FACEBOOK™), checking in to locations, either in a physical or virtual manner, or the like. The events composing the sequence may further comprise events relating to the vendor, such as visiting the vendor's store. The sequence may comprise any combination of the different events described above or other events similar thereto.

In some exemplary embodiments, the asset templates may be cross-enterprise assets that are identically defined for and redeemable by the participating vendors. The cross-enterprise assets may utilize a cross-enterprise language to describe the benefit, redemption condition or other properties of the asset template in a manner that is implementable by the different vendors. Additionally or alternatively, the asset templates may be used to generate concrete assets upon matching. In response to a match between an asset template and a member of a vendor, a concrete asset may be generated that is suitable to the vendor. It will be noted that the member may be a member of several vendors. The matching logic may determine a matched vendor, in the context of which, the member is matched to the asset template. The concrete asset may be generated based on the matched vendor.

In some exemplary embodiments, the campaign may be initiated by a brand owner. The brand owner may provide the funding for the benefit provided by the asset template. In some exemplary embodiments, the brand owner may define the asset template without additional constraints, to allow the member to immediately redeem the benefit. Using an electronic negotiation system, the brand owner may transmit an offer for a campaign to a plurality of vendors. Each vendor may either accept or decline the offer. In some cases, the vendor may propose a modification to the offer, such as defining a redemption condition to the asset template. The brand owner may be informed of the proposed modification. The brand owner may accept the modification, decline it, or propose a re-modification to the modified offer to be approved by the vendor. In some exemplary embodiments, after negotiation is concluded a set of vendors approving the same campaign may be established. In some exemplary embodiments, the brand owner may be interested in promoting her products. The vendors ride on the same campaign to increase their revenues, such as by limiting the redemption condition to specific “dead” timeslots (e.g., on Mondays, between 5 pm to 7 pm, or the like), by limiting quantities of the benefit, by requiring an additional purchase, or the like. In some exemplary embodiments, the brand owner may define a budget for the benefit, and the specific benefit may be selected by the vendor. In some cases, the brand owner may define a budget in addition to a selected benefit. For example, COCA COLA™ may define a budget of 1$ in addition to a bottle of soda. The vendor may decide on how to utilize the budget. One vendor may modify the offer to a bottle of soda and French fries with every hamburger purchased on Monday. The cost of the French fries is funded by 1$ by COCA COLA™. If the cost exceeds 1$, the vendor participates in its funding. Another vendor may modify the offer to every day between 2 pm and 4 pm, get a 1$ discount and a COCA COLA with every meal you purchase.

In some exemplary embodiments, different vendors may provide different modifications to the campaign. The vendor-defined campaign modification which may be a vendor-defined addition to the campaign definition may be obtained and applied to determine a modified campaign definition. The modified campaign may define different rules than originally defined by the campaign definition. In some exemplary embodiments, the campaign modification may comprise a modified definition of an asset template. In some exemplary embodiments, the redemption condition of the asset template may modified. Additionally or alternatively, the campaign modification may define an added benefit to the asset template. In such a case, the added benefit may be bestowed upon the member only in case the asset template is redeemed in the vendor's business, as opposed to if the asset template is redeemed at another vendor's business. Additionally or alternatively, the campaign modification may comprise an added matching logic definition which defines one or more added constraints on matching an asset template with a member of the specific vendor. A concrete matching logic may be determined based on the generic matching logic of the campaign and based on the added matching logic. The generic matching logic may be applied with respect to one vendor, whereas the concrete matching logic may be applied with respect to another vendor. In some exemplary embodiments, different vendors may define different concrete matching logics, each of which applicable thereto. In some exemplary embodiments, each data set may be queried using a query generated based on the relevant matching logic. In some exemplary embodiments, a base query may be generated based on the generic matching logic and addendum thereto may be generated individually, thereby reducing overhead from duplicate processing of the generic matching logic. Additionally or alternatively, the base query may be applied on an aggregated data set and an added filtering may be applied based on the add matching logic, such as SELECT*FROM RESULTS WHERE VENDOR_ID=ID AND NOT (ADDED_MATCHING_LOGIC_CRITERIA). Additionally or alternatively, a base query may be applied on all data sets and a second query, based on the added matching logic, if such exists, may be individually applied in each data set depending on the definitions of the vendor.

In some exemplary embodiments, consumer behavior relating to the response to the campaign may be gathered. In some exemplary embodiments, analytics may be applied on raw data to generate the consumer behavior data. In some exemplary embodiments, the consumer behavior data may be retained in the respective vendor's data set, such that the information may be available for the vendor and unavailable for external entities, such as a brand owner, thereby preserving confidentiality of the data and privacy of users. A continuation campaign may be established, where the matching logic may be based, at least in part, on the actions of the members in response to the original campaign. For example, the continuation campaign may assign assets only to consumers who redeemed their asset in the original campaign, only to consumers who redeemed their asset within a given time period, only to consumers who were assigned the asset but did not redeem it, or the like. In some exemplary embodiments, the disclosed subject matter may enable the brand-owner to re-target consumers, without knowing their identity, and without relying on temporal identification thereof (e.g., cookie files, IP addresses, or the like). The re-targeted campaign may be performed without disclosing the confidential information itself and without giving access to such data to anyone external to the vendor. In some exemplary embodiments, the brand-owner may not be aware of the identity of the members who were assigned assets in the original campaign and still may be able to re-target such members.

In some exemplary embodiments, a query based on the matching logic may be responsive to computed and non-computed data. The non-computed data may be raw data obtained directly from the member. The computed data may be data computed based on raw data, such as computed labels. The computed data may be based on a formula which is based on other computed or non-computed data.

In some exemplary embodiments, the query may be performed with respect to each data set of each vendor. Additionally or alternatively, the query may be performed on an aggregated data set. The aggregated data set may uniquely identify each member, and unite computed data available from different vendors. In some cases, the aggregated data set may further unite raw data from different vendors. As a result, using an aggregated data set may allow for the query to refer to information which may not be available at the specific data set. For example, a member may have provided her age to TIFFANY'S™ but not to MCDONALD'S™. The aggregated data set may include the age information even if TIFFANY'S™ is not participating in the campaign. In some cases, the raw data is the birth day, while the age is a computed data. In some cases, instances universal member properties from different vendors may be aggregated. As an example, a VIP property may exist if the member is considered VIP in all of the data sets in which she appears. As another example, the VIP property may exist if the member is considered VIP for most, for some, for at least one, for at least a predetermined portion of the vendors, for vendors of a specific field (e.g., for all vendors relating to the fashion industry) or the like. In some exemplary embodiments, the query may include a criteria referring to the universal member property in the vendor's data set and a criteria referring to the same universal member property in the aggregated data set (e.g., comparing the status of the property).

Additional technical problem, solution and effects may be apparent to a person of ordinary skill in the art in view of the present disclosure.

The disclosed subject matter may provide for one or more technical improvements over any pre-existing technique and any technique that has previously become routine or conventional in the art.

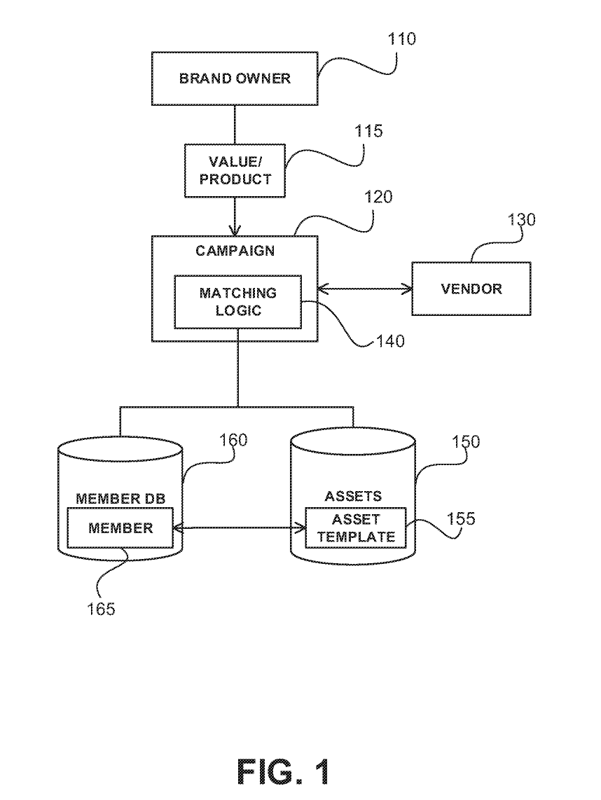

Referring now to FIG. 1 showing a computerized environment, in accordance with some exemplary embodiments of the subject matter.

A Brand Owner 110 may wish to launch a Campaign 120. Brand Owner 110 may be an owner of a brand having no retailer capabilities and requiring vendors to directly reach her customers. Brand Owner 110 may define Value/Product 115 to be bestowed on members as part of Campaign 120. In some exemplary embodiments, Brand Owner 110 may provide funding for the Value/Product 115. In some exemplary embodiments, Brand Owner 110 may define for Campaign 120, target audience using one or more universal member properties which are applicable to many vendors, such as Vendor 130. Additionally or alternatively, redemption conditions for the Value/Product 115 may be defined in the campaign definitions. As an example, Brand Owner 110 may wish to provide a monetary benefit to anyone who purchases COCA-COLA ZERO™ soda. As an alternative example, Brand Owner 110 may wish to target a certain population and provide them with a free COCA COLA ZERO™. In both cases, the Brand Owner's 110 product, COCA COLA ZERO™ is promoted. In some exemplary embodiments, the product, the redemption condition or additional properties relevant to Campaign 120 may be defined using a universal catalog property which is applicable to different vendors. In the examples above, the product may be identified using a universal catalog property uniquely identifying COCA COLA ZERO™, regardless of its actual product number or name in the Vendor's 130 catalog which may be different from one vendor to the other (e.g., ZERO in one catalog, COKE 0 in another, and COKE Z in yet another catalog).

Vendor 130 may negotiate and propose modification to Campaign 120, such as adding constraints and limitations, adding additional benefit, or the like. As a result, Vendor 130 may ride on the benefit funded by Brand Owner 110 to promote her business. For example, consider again the example above, instead of bestowing COCA COLA ZERO™ to each member of the target audience, Vendor 130 may propose that such benefit will be redeemed only when accompanied by a purchase of a hamburger, not redeemable at peak hours, or the like. In some exemplary embodiments, the proposal may be provided using universal member properties, universal catalog properties, or the like. Additionally or alternatively, concrete items from the Vendor's 130 catalog may be used by Vendor 130 to define the modification. The concrete items may be translated automatically to universal catalog properties.

In some exemplary embodiments, Brand Owner 110 may accept the proposed modification. Campaign 120 will be defined according to the accepted modification and the campaign may commence. In some cases, Brand Owner 110 may accept the modification only with respect to the Vendor 130 and therefore Campaign 120 may provide different definitions for Vendor 130 than other participating vendors (not shown). Additionally or alternatively, the modification may be applied on the entire campaign and each participating vendor that previously agreed to participate may be notified to determine if she agrees to the modification, wishes to re-modify it, or decline the proposal altogether.

In some exemplary embodiments, Brand Owner 110 may reject the modification and decline to modify the campaign as proposed. In such a case, Vendor 130 may be notified that her proposal was rejected, and she may provide a different proposal or opt to either participate or not participate in the existing campaign.

In some exemplary embodiments, Brand Owner 100 may propose a re-modification based on the modification. As an example, the re-modification may attempt to relax a redemption condition proposal. As another example, the re-modification may further restrict the target audience beyond the original definition and/or the definitions of the modification. In some exemplary embodiments, the re-modification may be proposed solely to Vendor 130. Additionally or alternatively, the re-modification may be proposed as a unanimous modification to all participating vendors.

In some exemplary embodiments, the negotiation process may be performed using an electronic messaging interface, enabling efficient communication between the parties. The proposals and modifications may be provided in electronic format and may be automatically translated from universal member properties and universal catalog properties to concrete properties and vice versa. In some cases, an estimated overall budget, or estimated overall number of assets may be automatically computed based on the data set of Vendor 130 and based on an automated estimation of the matched target audience in the data set.

In some exemplary embodiments, several vendors may be aligned together as a group of vendors and may wish to operate in a unified manner. As an example, a plurality of vendors that are located adjacently to one another may decide to make use of the value (115) funded by Brand Owner 110 to provide a campaign that requires interaction with two or more vendors (e.g., redemption condition requires purchasing at vendor X before receiving benefit at vendor Y), or which provides for alterative benefits from alternative vendors. Additionally or alternatively, the campaign may be initiated by a non-brand owner, such as by a vendor. In some cases, campaigns may be created based on a group of vendors that grouped together in an ad-hoc manner for the campaign itself

Campaign 120 may define a Matching Logic 140 to be applied when the campaign is launched. Matching Logic 140 may define conditions for matching of members to assets in accordance with Campaign 120. The conditions may include values of raw data, of computed data, of universal member properties, or the like. In some cases, the conditions may rely on the member having a label (e.g., VIP label, indicating a VIP member).

When Campaign 120 is created, a set of Asset Templates 155 may be created and retained in an Asset Repository 150. Asset Template 155 may be a universal asset redeemable in different participating vendors. Additionally or alternatively, Asset Template 155 may be a template based on which a concrete asset is generated when the asset is matched to a Member 165, so as to be redeemable in the vendor to which Member 165 belongs. In some exemplary embodiments, Asset Template 155 may define the benefit which is provided to the member. Additionally or alternatively, Asset Template 155 may define redemption conditions which when held, the benefit is redeemable. The properties of Asset Template 155 may be defined using universal catalog properties and/or universal member properties so as to allow for cross-enterprise usage of the Asset Template 155.

When Campaign 120 is launched, such as at predetermined time defined in Campaign 120, or upon an instruction by the owner of Campaign 120 (e.g. Brand Owner 110), Matching Logic 140 may be applied on data sets of members, such as retained in Member Database 160. The data sets may be retained in a single database, in different databases, in different storage devices, or the like. Each data set may relate to a different vendor, such as 130. In some exemplary embodiments, Matching Logic 140 may be applied on an aggregated data set which comprises information obtained from a plurality of data sets of different vendors, some of which may not participate in Campaign 120. Matching Logic 140 may uniquely match Asset Template 155 of Campaign 120 with a Member 165 of a participating vendor (e.g., 130). The match may be implemented so as to be persistent and remain in the future. The matching may be performed while Member 165 is online (e.g., connected to a website, using an app, or the like), or while Member 165 is offline. The unique association may survive Member 165 logging off, and will remain if Member 165 logs on again. In some cases, Member 165 may be notified of the matched Asset template 155 via the online representation of Vendor 130. Additionally or alternatively, the notification may be manual notification, such as by a representative of Vendor 130 at a location of Vendor 130. The representative may be informed of the need to notify Member 165 by a PoS device when an identification of Member 165 (e.g., name, Facebook™ account, email, phone number, loyalty membership information, or the like) is provided.

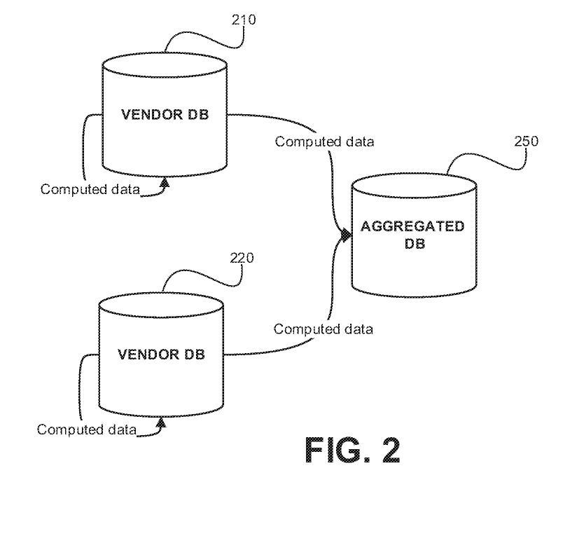

Referring now to FIG. 2 showing a schematic diagram of data sets, in accordance with some exemplary embodiments of the disclosed subject matter.

Each vendor may have a different data set, referred to as vendor DB, such as 210, 220. The data set may retain raw information which were obtained from the member during registration, or obtained based on interaction by the member with the vendor, such as purchase history, engagement history with an online representation, usage of loyalty benefits, or the like. The data set may further comprise computed data which is computed based on other data retained in the vendor DB, such as raw data or other computed data. The computed data may be computed on the fly when accessed, periodically, continuously when potentially modified, or the like. In some exemplary embodiments, the computed data may comprise computation of values for universal member properties based on a vendor-specific definition thereof, such that each vendor may have a different computation used for determining the value of the same universal member property. The value may be computed based on data relating to the same member. Additionally or alternatively, the value may be computed based on data relating to other members, such as in case the universal member property defines a relative property that is relative to other members (e.g., “big spender” may be defined as a member spending more than 90% of the members).

Aggregated DB 250 may be created and may be used to aggregate data from different vendor DBs (210, 220). Aggregated DB 250 may comprise computed data that is computed based on values in one or more vendor DBs (210, 220). In some cases, the computed data may be computed based on a data set of a vendor who does not participate in the campaign. As a result, information not available to the participating vendors may be available to be used for matching asset templates. As an example, a birthday may be available in one vendor's data set and used to compute an age of the member to be used for all campaigns. Additionally or alternatively, age prediction may be performed based on data in different vendors' data sets, thereby potentially increasing the precision and accuracy of the prediction. Additionally or alternatively, the computed data may be a universal member property that is contingent on the member's activity in different vendors. For example, a member may be considered a VIP member in the fashion industry if in 80% of the fashion-related vendors which include her in their members data set, she is considered a VIP member.

It will be noted that the disclosed subject matter may make use of a decentralized data set. In the Internet advertising realm it is customary for the advertising agency to gather information about the user from different websites. The information is obtained directly by the agency, such as by injecting its tracking code to different websites. The website owner herself is unaware of the information and such information is not available for her use. Instead, the information is kept as a potential trade secret of the agency. The agency is then able to obtain different information from various websites about the same user and to employ analytics to be useful for advertising. In some exemplary embodiments of the disclosed subject matter, the information available for the campaign is obtained from de-centralized data sets, each of which comprising business data of the vendors themselves. Such information may comprise information that is normally unavailable to the agency, such as complete purchase history and engagement and loyalty usage history of the member throughout her interactions with the vendor. The agency is also dependent on some ability to temporarily identify a same user in different web sessions, such as using a cookie, based on IP address, or the like. However, such techniques only provide for temporary identification and a same user may be mistakenly identified as different users in different sessions. Moreover, such techniques are unable to provide for long history of activity, such as years or months, as the temporary identification is likely to remain in effect for only a relative short period of time (e.g., days to weeks).

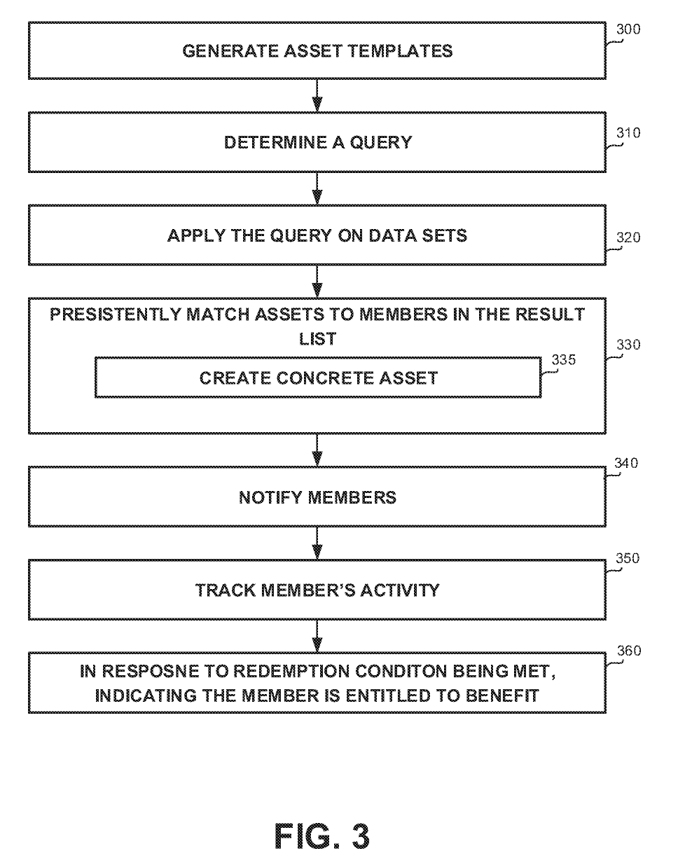

Referring now to FIG. 3 showing a flowchart diagram of a method, in accordance with some exemplary embodiments of the subject matter.

On Step 300, asset templates may be generated. The asset templates may be generated based on the campaign definitions. In some exemplary embodiments, the definitions may explicitly indicate a quantity of asset templates. Additionally or alternatively, the definitions may implicitly indicate a quantity, such as by defining a budget. The quantity may be a largest quantity of asset templates whose total cost of benefits is within the budget. The asset template may define a benefit for redemption. The benefit may be indicated using a universal catalog property thereby being cross-enterprise. Additionally or alternatively, the asset template may define a redemption condition. The redemption condition may be expressed using universal catalog properties, universal member properties, or the like, whereby the redemption condition may be cross-enterprise.

On Step 310, a query may be defined and on Step 320 the query may be applied. The query may be defined based on the matching logic provided in the executed campaign. The query may be configured to select members which adhere to the rules and conditions defined in the matching logic. In some exemplary embodiments, the query may comprise a filtering condition configured to filter some of the members when the query is applied (e.g., a where clause in an SQL query). The filtering condition may be based on a value of a universal member property. In some exemplary embodiments, the query may be responsive to raw data, to computed data, to a combination thereof, or the like. In some exemplary embodiments, several queries may be generated, such as a base query and an addendum query. The base query may be generated for several vendors and for each vendor a potentially different addendum query may be applied. The queries may be applied together simultaneously. Additionally or alternatively, the base query may be applied and additional filtering may be applied on its results thereafter for each vendor.

In some exemplary embodiments, the list of members may be further filtered, such as to conform to the quantity of assets available in the campaign which may be translated into a size limit parameter. The additional filtering may be performed based on a ranking of members which may be inter- or intra-vendor ranking. In some exemplary embodiments, the ranking may be affected by a last update time of the member. The last update time may be a last transaction time, a last connection time to a digital representation of the vendor, or the like.

In some exemplary embodiments, concrete assets may be generated before persistently matching assets to members (335). The concrete asset may be a concrete implementation of the asset template provided in non-cross-enterprise manner, and being applicable to only a sub-portion of the participating vendors. The concrete asset may be generated so as to be applicable to the vendor whose data set comprised the data which caused the member to be selected. For example, the member may be a member of several participating vendor. However, the match may be attributed to one vendor and accordingly the concrete asset may be generated to match said one vendor.

On Step 340, the members which were matched may be notified of the new asset that is at their disposal. The members may be notified via a digital representation of the vendor (e.g., website, bot, app, or the like). The notification may be provided in a push or pull manner. In some exemplary embodiments, a text message, a mobile push notification, an instant message, or a similar message may be sent to the member to notify her of the new asset. Additionally or alternatively, it may be tracked whether the notification was sent and to whom and potentially whether it was actually received (e.g., viewed) by the member. In case there was no notification provided to the member or if the notification was ineffective and did not reach her, the member may be notified in her next visit to the location of the vendor. In some exemplary embodiments, a PoS device in which the identification information of the member are provided, such as during a transaction in the location, may be configured to notify the representative of the vendor of the newly matched asset. Accordingly, the representative may manually inform the member of her asset. The representative may indicate to the PoS device that the notification was provided and was effective so as to avoid having the system attempt to continue providing notifications—either manually or in a non-manual manner—to the member.

On Step 350, the member's activity may be tracked. A computerized system may track engagement of the member, her transactions, or the like, to determine whether the redemption condition is held. In some cases, the redemption condition requires a sequence of events over time, and therefore inter-session tracking may be required. In some cases, the asset template may be updated to indicate each event in the sequence that has occurred so as to keep a record of the current state of the redemption condition. The sequence of events may be a sequence of separate purchases. As an example, the asset template may be a punch-card requiring several purchases of an item before bestowing the benefit. The system may track the member's activity and record each relevant transaction. Additionally or alternatively, the sequence of events may comprise engagement-related activities, such as checking in to a social media, posting on line, logging on a digital representation of the vendor, or the like. In some exemplary embodiments, the sequence may be heterogeneous and comprise different types of events, whether in specific order therebetween or without a requirement on their inter-order.

On Step 360, in response to the redemption condition being met, as determined based on the tracking (350), indicating that the member is entitled to the benefit. In some exemplary embodiments, the member may be notified in a manner similar to that of Step 340. The benefit may be bestowed without manual authorization of the member, such as by automatically discounting her bill, vending a new item, or the like. Additionally or alternatively, the member may be asked to decide when to claim the benefit. As long as the benefit is not claimed, the member may be re-notified when visiting the location of her possibility to claim the benefit, either manually or via a digital representation of the vendor.

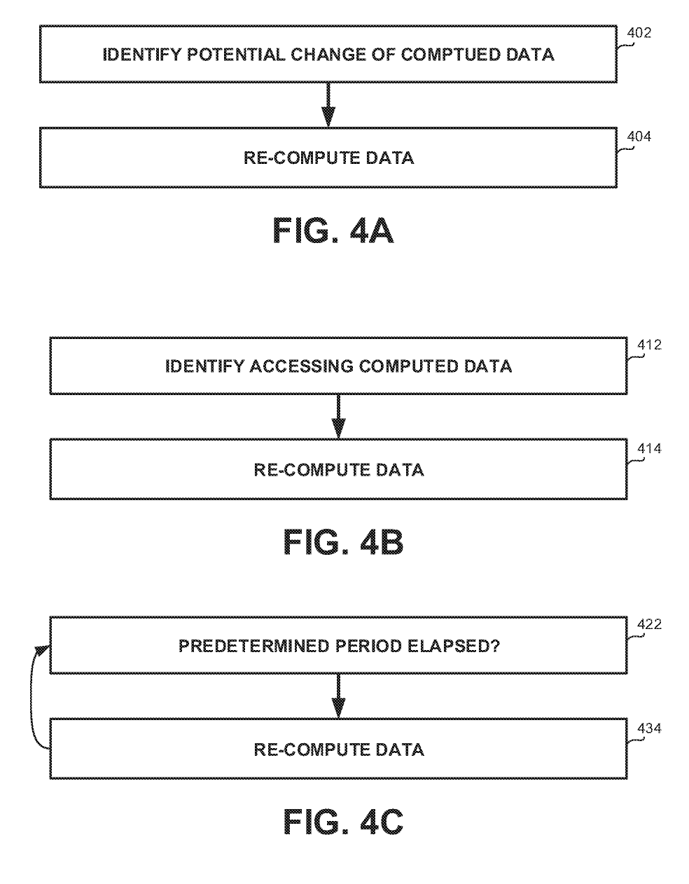

Referring now to FIGS. 4A-4C showing flowchart diagrams of methods, in accordance with some exemplary embodiments of the subject matter.

On Step 402, a potential change of computed data is identified, such as modifying a value that has the potential of changing the computed data. The computed data may be a universal member property, which may be implemented using a labeling. In response, the data may be re-computed (404) to ensure that the computed data is up-to-date.

On Step 412, when computed data, such as a value of a universal member property, is accessed or queried, the data may be re-computed (414). In some exemplary embodiments, the re-computation may only occur if after the last computation thereof, a change in raw or computed data that has the potential to affect the computed data was made.

Steps 422-434 exemplify period updating of the computed data. The computed data is re-computed periodically, after a predetermined period has elapsed.

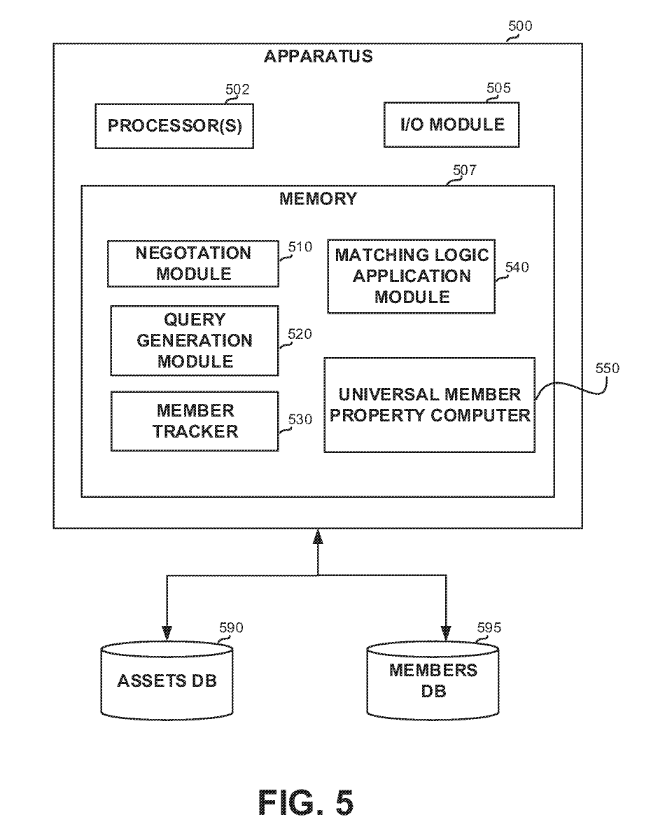

Referring now to FIG. 5 showing an apparatus in accordance with some exemplary embodiments of the disclosed subject matter.

In some exemplary embodiments, Apparatus 500 may comprise one or more Processor(s) 502. Processor 502 may be a Central Processing Unit (CPU), a microprocessor, an electronic circuit, an Integrated Circuit (IC) or the like. Processor 502 may be utilized to perform computations required by Apparatus 500 or any of it subcomponents.

In some exemplary embodiments of the disclosed subject matter, Apparatus 500 may comprise an Input/Output (I/O) module 505. I/O Module 505 may be utilized to provide an output to and receive input from a user, to communicate with other computerized devices, such as query a remote database, or the like.

In some exemplary embodiments, Apparatus 500 may comprise Memory 507. Memory 507 may be a hard disk drive, a Flash disk, a Random Access Memory (RAM), a memory chip, or the like. In some exemplary embodiments, Memory 507 may retain program code operative to cause Processor 502 to perform acts associated with any of the subcomponents of Apparatus 500.

Negotiation Module 510 may be configured to allow for entities such as brand owners and vendors, wishing to participate in a campaign negotiate its terms. Negotiation module 510 may enable each party to accept, decline or propose a modification on a proposal provided by another party. Modifications may be applied in uniform manner on the campaign or may be limited only to a specific party requesting them.

Query Generation Module 520 may be configured to generate one or more queries based on a matching logic. The query may be applied on Members Database 595. The query may be adapted to a database scheme of the data set of a specific vendor. Additionally or alternatively, the query may be adapted to be executed against an aggregated data set. In some exemplary embodiments, a single matching logic may be used to generate several queries, such as a query for each different vendor. Additionally or alternatively, a generic matching logic together with one or more concrete matching logics may be used to generate a plurality of queries. Additionally or alternatively, a base query may be generated, such as based on a generic matching logic, which may be used in uniform for all vendors. An added filtering query may be generated to be applied on the results of the base query. The added filtering query may be different for different vendors, such as based on the concrete matching logic thereof. Additionally or alternatively, the base query and added filtering query may be executed together as a single query, on the relevant data set. Additionally or alternatively, the base query may be executed on an aggregated data set and the added filtering query of each vendor may be executed on the portion of the results which are obtained from the relevant vendor.

Member Tracker 530 may be configured to track behavior of a member over time. In some exemplary embodiments, Member Tracker 530 may be configured to update Members Database 595 of the vendor to include engagement data relating to the engagement of the members to a campaign. Monitoring the behavior of the members may be performed directly. Additionally or alternatively, Members Tracker 530 may be configured to monitor the behavior indirectly based on data retained and updated in Members Database 595 and/or Assets Database 590. Member Tracker 530 may be configured to query Members Database 595 to retrieve raw or computed information on the behavior of the member. Additionally or alternatively, Member Tracker 530 may monitor the behavior of the member directly and optionally update Members Database 595. In some exemplary embodiments, Member Tracker 530 may track events related to the member over time, such as events related to engagement of the member, events related to transactions performed by the member, or the like. The tracking information may be used to update assets in Assets Database 590, such as assets whose redemption condition is contingent on the occurrence of (an ordered or unordered) sequence of events. Member Tracker 530 may be configured to record events and update any asset which is contingent upon the event that the event has occurred. Assets which require several events may become redeemable when all relevant events have occurred. In some exemplary embodiments, in case an order of events is specified, the event is marked as occurred only if it has occurred in the correct order. Otherwise, the event is disregarded and a next event is monitored for. In some exemplary embodiments, Member Tracker 530 may be configured to track results of a campaign. Consumer behavior data relating to member's response to a campaign may be gathered and retained in the Members Database 595. In some cases, the Members Database 595 may indicate which members were covered by the campaign (e.g., matched an asset template as part of the campaign). Additionally or alternatively, Members Database 595 may indicate which members redeemed the asset template. In some exemplary embodiments, the retained information may be used as part of a matching logic in a continuation campaign. The continuation campaign may match members of the previous campaign or portion thereof, such as those members who redeemed, those members who did not redeem, those members who interacted with the asset template but did not redeem, those members who were not notified of the asset template within a predetermined timeframe of the campaign being launched and did not redeem, or the like. Apparatus 500 may enable the launch of a re-targeting campaign without disclosing confidential information such as the identity of the members who were targeted by the first campaign.

Matching Logic Application Module (MALM) 540 may be configured to apply the matching logic using Query Generation Module 520 and to uniquely and persistently match the asset templates based on the query results. In some exemplary embodiments, members identified by the query may be sorted in accordance with a ranking. Each member may be matched uniquely and persistently with an asset template in accordance with the sorted order, until the inventory allotted for the campaign is depleted. MALM 540 may be configured to update Members Database 595 to indicate the unique and persistent association of a member to a respective asset template. Additionally or alternatively, MALM 540 may be configured to update Assets Database 590 to indicate the unique and persistent association of an asset template to a respective member. Additionally or alternatively, MALM 540 may be configured to determine whether a concrete asset is required to be generated based on the asset template, and if so, to generate the concrete asset. The generated asset may be uniquely and persistently matched to a member, and Members Database 595 and/or Assets Database 590 may be updated accordingly. In some exemplary embodiments, asset template which was used as a basis for the generation of a concrete asset may be indicated as used. In some exemplary embodiments, a single asset template may be indicated to represent an inventory of concrete assets. The number of remaining concrete assets that can be generated may be updated.

In some exemplary embodiments, MALM 540 may be configured to update a billing module (not shown) for accounts settling. A cost of each asset template that is matched may be accounted for and settled between the vendor and the campaign initiator. Additionally or alternatively, the accounts settling may be performed only with respect to redeemed asset templates, as identified by Member Tracker 530.

Universal Member Property Computer 550 may be configured to compute a value of a universal member property in a data set for a vendor. In some exemplary embodiments, Universal Member Property Computer 550 may be invoked periodically. Additionally or alternatively, Universal Member Property Computer 550 may be invoked whenever data that may affect the universal member property is updated. In some exemplary embodiments, Universal Member Property Computer 550 may be configured to compute the value on demand when the value is retrieved to be used. In some exemplary embodiments, Universal Member Property Computer 550 may be configured to access Members Database 595 to compute the value of the universal member property. In some exemplary embodiments, Universal Member Property Computer 550 may be configured to update Members Database 595 to retain the computed value. In some exemplary embodiments, the computed value may either be TRUE or FALSE and a label may be added/removed to a member in Members Database 595 based on the valuation. In some exemplary embodiments, Universal Member Property Computer 550 may utilize a different definition for the same universal member property in different data sets. For each vendor, a different formula may be defined. The formula may be defined by the vendor, and potentially may be based on a default formula. In some exemplary embodiments, in case a vendor does not provide an explicit definition of the universal member property, a default definition may be used. Additionally or alternatively, in case the vendor does not set a definition (either specific definition or by approving a default definition), the universal member property may not be computed for the vendor's members. As a result, all members of the vendor may be considered as not having the universal member property (e.g., not being labeled using a corresponding label).

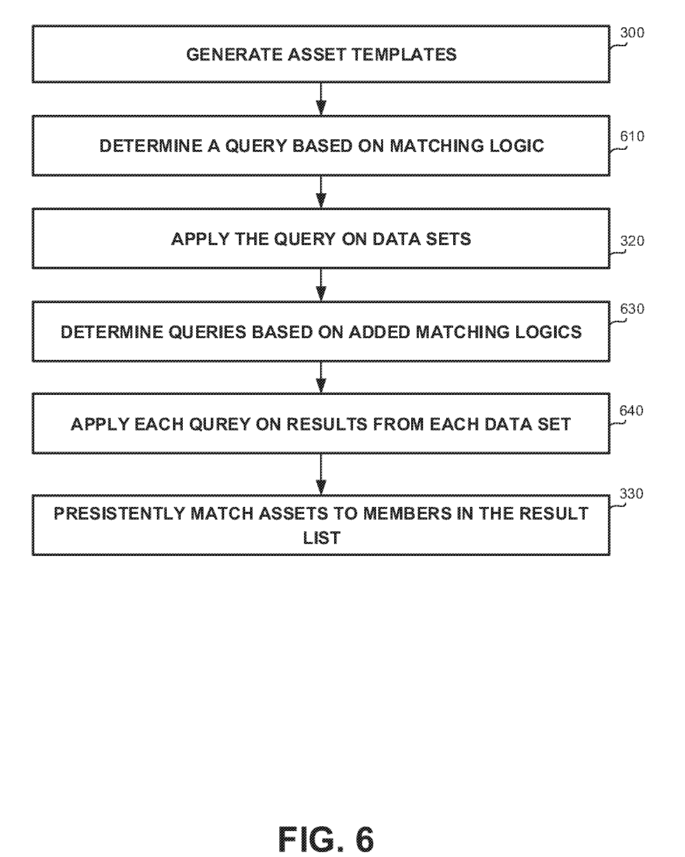

Referring now to FIG. 6 showing a flowchart diagram of a method, in accordance with some exemplary embodiments of the subject matter.

On Step 610, a query is determined based on the matching logic. The query may be a base query that is relevant to a plurality of different vendors, each of which having a different concrete matching logic that are based on a generic matching logic. In some exemplary embodiments, the concrete matching logic may include additional conditions or requirements on top of the base query. Additionally or alternatively, one or more vendors may have a concrete matching logic that is identical to the generic matching, while other vendors may have concrete matching logics which involve added matching logics. The base query may be applied on the data sets (320), either in a unified or non-unified manner.

On Step 630, queries may be determined based on added matching logics. For each vendor having an added matching logic, a query may be determined. The queries may than be applied on the results from each data set obtain in Step 320.

In some exemplary embodiments, a result obtained from all data sets may be obtained and then filtered based on the added matching logics, by filtering results from each vendor based on its respective added matching logics. In such an embodiment, the base query may be performed once on an aggregated data set, thereby reducing the Database Management System (DBMS) overall execution time and overhead, thereby increasing efficiency. Additionally or alternatively, a single query may be created for each vendor, and each such query may be applied so that the filtering is performed in a single query. In such an embodiment, the overhead may be relatively increased, however each query may be executed in a relatively more efficient manner, reducing overhead of obtaining a large list of members and filtering it. In some exemplary embodiments, both options may be performed at the same time, until one method provides a final result. At such a point, both querying methods may be halted. As a result, in case different scenarios cause different methods to out-perform do not adversely affect execution time. Regardless of which method out performs, each scenario may be handled in the optimal manner. In some exemplary embodiments, based on historical information or based on predetermined rules, it may be predicted which method out-performs, such as based on the number of members in the database, based on the number and types of constraints in the query, based on which predicates are used in the query, or the like.

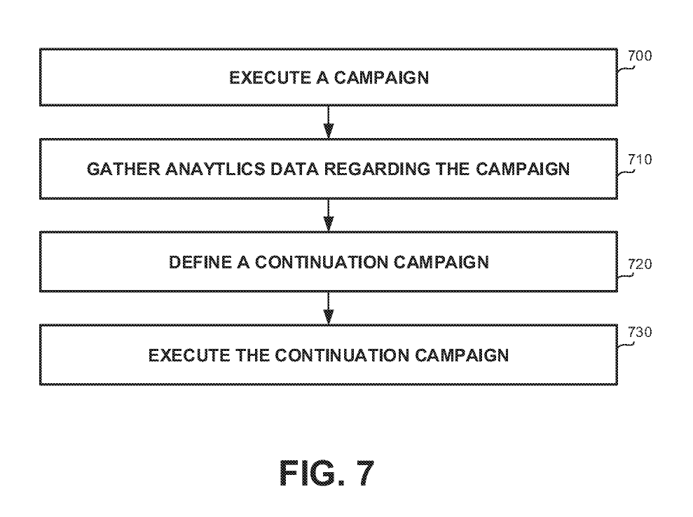

Referring now to FIG. 7 showing a flowchart diagram of a method, in accordance with some exemplary embodiments of the subject matter.

On Step 700, a campaign is executed. The campaign is executed by matching assets to members and allowing the members to redeem the benefits thereof

On Step 710, analytics are gathered about the executed campaign. The analytics may include information regarding to matching of asset templates, regarding the audience which was matched, engagement of the audience, redemption information and fulfillment of other user-defined goals. Additionally or alternatively, the analytics data may provide aggregated data of groups of members above a predetermined size (e.g., comprising at least about five members, about ten members, or the like), thereby providing aggregated useful data to the campaign owner without disclosing potentially confidential information about the users, and specifically their identity. In some exemplary embodiments, as part of the engagement of the members, they may opt to disclose their identity to the campaign owner and the analytics may provide aggregated data together with member-specific data for the members who opted to disclose their identity.

On Step 720, a second campaign may be defined. The second campaign may re-target some or all of the audience of the first campaign. Additionally or alternatively, the second campaign may exclude portions of the audience of the first campaign, such as portions which were unaffected by the first campaign or portions which exhibited engagement levels below or above a predetermined threshold. In some exemplary embodiments, second campaign may include or exclude portions of the audience of the first campaign without providing any access to the campaign owner to the identity of the members of audience.

On Step 730, the second campaign may be executed. In some exemplary embodiments, analytics of the second campaign may be gathered and provided to the campaign owner. Additionally or alternatively, the analytics of the first and second campaign may be shown together, in aggregated manner, while taking into account the overlap therebetween (e.g., same unique members may be included in both analytics data and may be accounted for only once in the aggregated analytics).

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A computer program product comprising a non-transitory computer readable storage medium retaining program instructions, which program instructions when read by a processor, cause the processor to perform a method, wherein the process is operating in a computerized environment, wherein the computerized environment comprises a plurality of data sets each of which retaining information relating to members in a customer base of a vendor, wherein the data sets potentially comprise confidential information regarding members that is not accessible to any entity external to the vendor, wherein the computerized environment comprises a plurality of catalogs each of which retaining a plurality of products or services offered by a vendor, wherein said method comprising:
generating a plurality of asset templates, wherein each asset template defines a benefit to a member and being redeemable through each one of a set of vendors participating in a campaign;
applying a matching logic to uniquely match each asset template with a single member, wherein the matching logic comprises at least one criterion used to determine whether a member is a match to an asset, wherein the at least one criterion comprise a universal member property, wherein the universal member property is a property of a member that is applicable by each participating vendor and is vendor-defined, wherein a value of the universal member property for a member with respect to a vendor is automatically computed based on a vendor definition and based on information of the member retained in a data set of the vendor, whereby providing a uniform cross-enterprise language useful for querying member information in data sets of different participating vendors, wherein said applying the matching logic comprises:
determining a query, wherein the query comprises a filtering condition that is based on the universal member property;
applying the query on the data sets;
retrieving a list of matched members based on the query; and
for each member in the list of matched members, persistently matching an asset template.

2. The computer program product of claim 1, wherein the list of matched members is obtained by filtering a result set returned from the data sets according to a filtering criterion.

3. The computer program product of claim 2, wherein the filtering criterion comprises a size limit parameter, wherein the size limit parameter is derived from a total number of asset templates allotted for the campaign.

4. The computer program product of claim 3, wherein each result in the result set is associated with a match ranking, wherein the filtering criterion is selected from the group consisting of: top ranking results according to associated match ranking; results with associated match ranking exceeding a predetermined threshold.

5. The computer program product of claim 2, wherein the filtering criterion is based on a last update time of the members, wherein the last update time is a latest time out of the following: a last transaction time; and a last connection time wherein the last transaction time is a time of a last purchase made by the member, wherein the last connection time is a time of a last interaction of the member with an application program of the participating vendor.

6. The computer program product of claim 1, wherein the value of the universal member property is re-computed based on raw data in the data set of the vendor.

7. The computer program product of claim 1, wherein the universal member property is selected from the group consisting of: expenditure level; products or services preference; payment habit; demographic property; engagement characterization and any combination thereof.

8. The computer program product of claim 1, wherein the universal member property is a Very Important Person (VIP) property indicating the member is considered a VIP customer for the vendor.

9. The computer program product of claim 1, wherein the universal member property is computed based on raw data comprising information selected from the group consisting of: consumption data, a demographic property, engagement information, information relating to loyalty and redemption of loyalty-related benefits, environmental properties, and a combination thereof.

10. The computer program product of claim 1, wherein each data set comprises a labeling for members denoting a respective universal member property, wherein the labeling is determined based on information of each member retained in the data set.

11. The computer program product of claim 10, wherein different vendors apply different criteria for labeling a member with a given universal member property.

12. The computer program product of claim 1, wherein the members are users capable of interacting with a digital representation of a participating vendor, whereby a member may be in an online or offline state with respect to the digital representation of the participating vendor, wherein the matching of an asset template to a member is performed while some of the members are in an online state and some of the members are in an offline state.

13. The computer program product of claim 1, wherein a first portion of members are notified of the matched asset template by a digital representation of a participating vendor, wherein a second portion of members are notified of the matched asset template at a point of sale of the participating vendor without interacting with the digital representation of the participating vendor.

14. The computer program product of claim 1, wherein the asset template is defined using a universal catalog property denoting corresponding products or services in different catalogs, whereby providing a uniform cross-enterprise language useful for defining the asset template in a uniform manner for each participating vendor.

15. The computer program product of claim 14, wherein the corresponding products or services are selected from the group consisting of: branded and generic versions of a same product or service; different species within a genus of products or services; and any combination thereof.

16. The computer program product of claim 14, wherein the universal catalog property denotes a class of products or services in a same catalog, whereby a redemption condition defined using the universal catalog property is met based on an activity relating to any product or service of the class.

17. The computer program product of claim 1, wherein the asset template defines a redemption condition that is contingent on an action by the member, wherein the redemption condition relates to a sequence of events over time, each of which pertaining to a separate action to be performed by the member.

18. The computer program product of claim 17, wherein the sequence of events comprises a sequence of purchases made by the member.

19. The computer program product of claim 1, wherein the plurality of asset templates are cross-enterprise assets identically defined for and redeemable by the participating vendors.

20. The computer program product of claim 1, wherein said method further comprising: in response to said matching, determining a vendor in which the asset template is redeemable; and generating a concrete asset based on the asset template, wherein the concrete asset is redeemable only by the vendor.

21. The computer program product of claim 1, wherein the campaign is launched responsive to a negotiation process between a brand owner providing funding of the benefit and each of a plurality of vendors, wherein the negotiation process comprises an offer sent from the brand owner to the vendor, an acceptance, decline or modification sent by the vendor to the brand owner in response to the offer, and acceptance, decline or re-modification sent by the brand owner to the vendor in response to the modification.

22. The computer program product of claim 1, wherein the campaign is launched responsive to a negotiation process between a the set of vendors, wherein the negotiation process comprises an offer sent from a first vendor to one or more other vendors, an acceptance, decline or modification sent by each of the one or more other vendors to the first vendor in response to the offer, and acceptance, decline or re-modification sent by the first vendor in response to the modification.

23. The computer program product of claim 1, wherein consumer behavior data relating to members' response to the campaign are gathered and retained in the respective data sets of vendors in response to the benefit being redeemed, wherein the method further comprising determining a continuation campaign wherein the matching logic is configured to apply a matching criterion that is defined, at least partially, as a function of the consumer behavior data, whereby members that previously redeemed the benefit of the campaign are re-targeted for the continuation campaign without confidential information thereof being disclosed.

24. The computer program product of claim 1, wherein the query is configured to be responsive to computed and non-computed data in the data sets, wherein said applying the matching logic further comprises: applying a second query on an aggregated data set comprising the data sets, whereby matching of a member in a data set of a first vendor is potentially based on information retained in a data set of a second vendor.

25. The computer program product of claim 23, wherein the aggregated data set comprises a data set of an additional vendor, wherein the additional vendor does not participate in the campaign, whereby matching is performed while taking into account information external to the set of vendors.

26. A system comprising said processor and a memory, wherein said memory

1. g the computer program product of claim 1.

27. A method implemented in a computerized environment, wherein the computerized environment comprises a plurality of data sets each of which retaining information relating to members in a customer base of a vendor, wherein the data sets potentially comprise confidential information regarding members that is not accessible to any entity external to the vendor, wherein said method comprising:
obtaining a campaign definition,
wherein the campaign definition comprises an asset template definition, wherein the asset template definition defines a quantity of assets template to be generated in a campaign, wherein the asset template definition defines a benefit to a member that is redeemable through each one of a set of vendors participating in a campaign, wherein the set of vendors comprises a first vendor and a second vendor,
wherein the campaign definition comprises a generic matching logic to uniquely match an asset template with a single member, wherein the generic matching logic is applicable to each vendor of the set of vendors participating in the campaign;
obtaining a campaign modification from the first vendor, wherein the campaign modification is a vendor-defined addition to the campaign definition;
determining a modified campaign definition based on the campaign definition and based on the campaign modification, wherein the modified campaign defines different rules for the first vendor than for the second vendor based on the campaign modification;
generating set of asset templates based on the modified campaign definition, wherein each asset template defines a benefit to a member and being redeemable through each one of the set of vendors;
applying a matching logic based on the modified campaign definition to obtain a list of matched members; and
for each member in the list of matched members, persistently matching an asset template from the set of asset templates.

28. The method of claim 27, wherein the campaign modification comprises a modified definition of an asset template, whereby an asset template that is matched to a member of the first vendor is different than an asset template that is matched to a member of the second vendor.

29. The method of claim 28, wherein the campaign modification defines a redemption condition for asset templates that is contingent on an action by the member, whereby the asset template matched to the member of the first vendor has a different redemption condition than the asset template matched to the member of the second vendor.

30. The method of claim 28, wherein the campaign modification defines an added benefit to the asset template, whereby the asset template matched to the member of the first vendor bestows the benefit and the added benefit, while the asset template matched to the member of the second vendor bestows the benefit without the added benefit.

31. The method of claim 27, wherein the campaign modification comprises an added matching logic defining one or more added constraints on matching an asset template with a member of the first vendor, whereby a concrete matching logic is determined based on the generic matching logic and based on the added matching logic, wherein said applying comprises applying the concrete matching logic with respect to the first vendor and applying the generic matching logic with respect to the second vendor, whereby different matching logics are applied to different vendors.

32. The method of claim 29, wherein a second concrete matching logic is determined based on the generic matching logic and based on a second campaign modification obtained from the second vendor, wherein said applying comprises applying the second concrete matching logic with respect to the second vendor.

33. A computerized apparatus having a processor and a memory, wherein the computerized apparatus operating in a computerized environment, wherein the computerized environment comprises a plurality of data sets each of which retaining information relating to members in a customer base of a vendor, wherein the data sets potentially comprise confidential information regarding members that is not accessible to any entity external to the vendor, wherein said processor being adapted to perform the steps of:
obtaining a campaign definition,
wherein the campaign definition comprises an asset template definition, wherein the asset template definition defines a quantity of assets template to be generated in a campaign, wherein the asset template definition defines a benefit to a member that is redeemable through each one of a set of vendors participating in a campaign, wherein the set of vendors comprises a first vendor and a second vendor,
wherein the campaign definition comprises a generic matching logic to uniquely match an asset template with a single member, wherein the generic matching logic is applicable to each vendor of the set of vendors participating in the campaign;
obtaining a campaign modification from the first vendor, wherein the campaign modification is a vendor-defined addition to the campaign definition;
determining a modified campaign definition based on the campaign definition and based on the campaign modification, wherein the modified campaign defines different rules for the first vendor than for the second vendor based on the campaign modification;
generating set of asset templates based on the modified campaign definition, wherein each asset template defines a benefit to a member and being redeemable through each one of the set of vendors;
applying a matching logic based on the modified campaign definition to obtain a list of matched members; and
for each member in the list of matched members, persistently matching an asset template from the set of asset templates.

34. The computerized apparatus of claim 33, wherein the campaign modification comprises a modified definition of an asset template, whereby an asset template that is matched to a member of the first vendor is different than an asset template that is matched to a member of the second vendor.

35. The computerized apparatus of claim 33, wherein the campaign modification comprises an added matching logic defining one or more added constraints on matching an asset template with a member of the first vendor, whereby a concrete matching logic is determined based on the generic matching logic and based on the added matching logic, wherein said applying comprises applying the concrete matching logic with respect to the first vendor and applying the generic matching logic with respect to the second vendor, whereby different matching logics are applied to different vendors.
